(19) United States
(12) Patent Application Publication
(10) Pub. No.: US 2024/0410698 A1
(43) Pub. Date: Dec. 12, 2024

(54) REMOTE CONTROL SYSTEM

(71) Applicant: TOYOTA JIDOSHA KABUSHIKI KAISHA, Toyota-shi (JP)

(72) Inventors: Takuro SAWANO, Nisshin-shi (JP); Kento Iwahori, Nagouya-shi (JP); Takeshi Kanou, Seto-shi (JP); Yasuyoshi Hatano, Nisshin-shi (JP); Keigo Ikeda, Nisshin-shi (JP); Shogo Yasuyama, Okazaki-shi (JP); Jyunya Katou, Toyota-shi (JP)

(73) Assignee: TOYOTA JIDOSHA KABUSHIKI KAISHA, Toyota-shi (JP)

(21) Appl. No.: 18/591,201

(22) Filed: Feb. 29, 2024

(30) Foreign Application Priority Data
Jun. 7, 2023 (JP) 2023-093949

(51) Int. Cl. G01C 21/20; G06T 7/00; G06T 7/70; G06V 20/52; B62D 65/18

(52) U.S. Cl. CPC G01C 21/20; G06T 7/0008; G06T 7/70; G06V 20/52; B62D 65/18; G06T 2207/30108; G06T 2207/30232; G06T 2207/30248; G06V 2201/08

(57) ABSTRACT

A remote control system for automatically moving a moving object by remote control, comprising a plurality of functional units that transmit and receive information to and from each other, wherein at least a part of the plurality of functional units detects the presence or absence of an abnormality in another functional unit by using information received from another functional unit.

### CROSS-REFERENCE TO RELATED APPLICATION

This application claims priority to Japanese Patent Application No. 2023-093949 filed on Jun. 7, 2023, incorporated herein by reference in its entirety.

### BACKGROUND

### 1. Technical Field

The present disclosure relates to remote control systems.

### 2. Description of Related Art

A technique for remotely controlling a vehicle to travel in a vehicle manufacturing process is known in the art (e.g., WO2016/066362).

### SUMMARY

Such remote control of a vehicle is implemented by processes that are performed by various functional units included in a remote control system. When an abnormality occurs in any of the functional units, a proper result cannot be obtained from the process performed by that functional unit, which may result in unstable remote control of the vehicle. Therefore, a technique for detecting the presence or absence of an abnormality in any functional unit included in a remote control system is desired.

The present disclosure can be implemented in the following aspects.

(1) According to an aspect of the present disclosure, a remote control system is provided that remotely controls a moving object to move automatically. The remote control system includes a plurality of functional units that sends and receives information to and from each other. At least part of the functional units detects presence or absence of an abnormality in a remainder of the functional units by using information received from the remainder of the functional units.

According to the remote control system, at least part of the functional units can detect the presence or absence of an abnormality in the remainder of the functional units by using the information received from the remainder of the functional units.
(2) In the remote control system, the functional units may include a route planning unit that determines a route along which the moving object is to be moved, and a moving object identifying unit that acquires either or both of a position and orientation of the moving object. According to the remote control system, it is possible to detect the presence or absence of an abnormality in the remote control system including the route planning unit and the moving object identifying unit.
(3) In the remote control system, the route planning unit and the moving object identifying unit may mutually detect the presence or absence of the abnormality.
According to the remote control system, since the route planning unit and the moving object identifying unit mutually detect the presence or absence of an abnormality, it is possible to more stably detect an abnormality.
(4) The remote control system may further include a functional unit that performs either or both of the following operations when the abnormality is detected in either or both of the route planning unit and the moving object identifying unit: reducing a moving speed of the moving object, and limiting a steering angle.
According to the remote control system, either or both of the operation of reducing the moving speed of the moving object and the operation of limiting the steering angle are performed when an abnormality is detected. This can reduce the amount of movement of the moving object and reduce the possibility that a problem with traveling of the moving object may occur.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram illustrating a schematic configuration of a remote control system according to the present embodiment;

FIG. 2 is a block-diagram illustrating a configuration of a vehicle and a remote control device; and

FIG. 3 is a flow chart showing a sequence of an abnormality detecting process according to the present embodiment.

### DETAILED DESCRIPTION OF EMBODIMENTS

### A. Embodiment

### A-1. System Configuration:

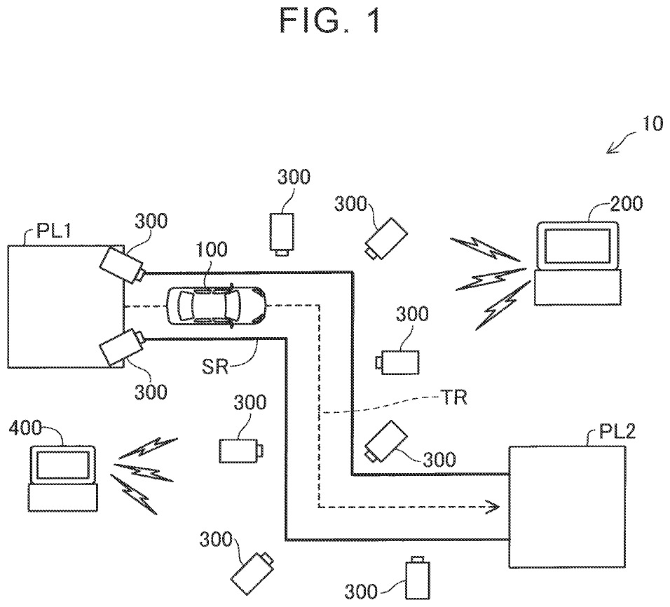

FIG. 1 is an explanatory diagram illustrating a schematic configuration of a remote control system 10 according to the present embodiment. The remote control system 10 includes one or more vehicles 100 as a moving object, a remote control device 200 that generates a control command for remotely controlling the vehicle 100 and transmits the control command to the vehicle 100, a plurality of vehicle detectors 300 that measure three-dimensional point cloud data of the vehicle 100, and a process management device 400 that manages a manufacturing process of the vehicle 100.

In the present embodiment, the vehicles 100 are configured as battery electric vehicle (BEV: Battery Electric Vehicle). The moving object is not limited to battery electric vehicle, and may be, for example, a gasoline-powered vehicle, a hybrid electric vehicle, or a fuel cell electric vehicle. The moving object is not limited to the vehicle 100, and may be configured as, for example, an electric vertical takeoff and landing machine (a so-called flying vehicle).

In the present embodiment, in a factory that manufactures the vehicle 100, remote control for causing the vehicle 100 to automatically travel is executed. The plant comprises a first location PL1 and a second location PL2. The first location PL1 is, for example, a location where the vehicle 100 is assembled, and the second location PL2 is, for example, a location where the vehicle 100 is inspected. The first location PL1 and the second location PL2 are connected by a traveling path SR on which the vehicles 100 can travel.

A plurality of vehicle detectors 300 for measuring the vehicle 100 are installed in the vicinity of the traveling path SR. The vehicle detector 300 is configured as a camera or a Light Detection And Ranging (LiDAR), and acquires images of the vehicle 100 and three-dimensional point cloud data.

The remote control device 200 generates a control command for causing the vehicle 100 to travel along the traveling path SR, and transmits the control command to the vehicle 100. The vehicle 100 travels in accordance with the received control command. Therefore, the vehicle 100 can be moved from the first location PL1 to the second location PL2 by remote control without using a conveying device such as a crane or a conveyor by the remote control system 10. Further, the remote control device 200 may generate a control command for controlling the operation of peripheral devices (not shown) existing in the vicinity of the traveling path SR, such as the vehicle detector 300, a shutter, and a power supplying device, and transmit the control command to the respective devices.

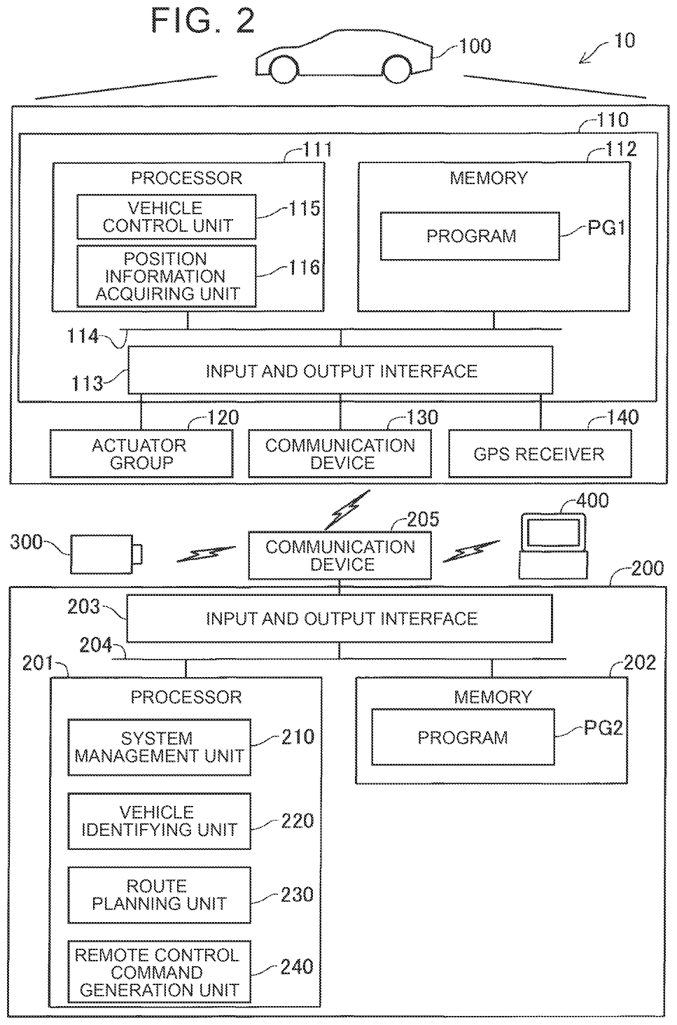

FIG. 2 is a block diagram illustrating a configuration of the vehicle 100 and the remote control device 200. The vehicle 100 includes a vehicle control device 110 for controlling each unit of the vehicle 100, an actuator group 120 driven under the control of the vehicle control device 110, a communication device 130 for communicating with the remote control device 200 by radio communication, and a GPS receiver 140 for acquiring position data of the vehicle 100. In the present embodiment, the actuator group 120 includes an actuator of a driving device for accelerating the vehicle 100, an actuator of a steering device for changing a traveling direction of the vehicle 100, and an actuator of a braking device for decelerating the vehicle 100. The driving device includes a battery, a traveling motor driven by electric power of the battery, and driving wheels rotated by the traveling motor. The actuator of the drive device includes a traveling motor. The actuator group 120 may further include an actuator for swinging the wiper of the vehicle 100, an actuator for opening and closing the power window of the vehicle 100, and the like. The vehicle 100 may also include various object detectors such as cameras, millimeter-wave radars, LiDAR, and the like.

The vehicle control device 110 includes a computer including a processor 111, a memory 112, an input/output interface 113, and an internal bus 114. The processor 111, the memory 112, and the input/output interface 113 are bidirectionally communicably connected to each other via an internal bus 114. An actuator group 120, a communication device 130, and a GPS receiver 140 are connected to the input/output interface 113.

In the present embodiment, the processor 111 functions as the vehicle control unit 115 and the position information acquiring unit 116 by executing a program PG1 stored in advance in the memory 112. The vehicle control unit 115 controls the actuator group 120. The vehicle control unit 115 can cause the vehicle 100 to travel by controlling the actuator group 120 in accordance with the operation of the driver when the driver is on the vehicle 100. The vehicle control unit 115 can also cause the vehicle 100 to travel by controlling the actuator group 120 in accordance with a control command transmitted from the remote control device 200, regardless of whether or not the driver is on the vehicle 100. The position information acquiring unit 116 uses GPS receiver 140 to acquire position information indicating the current position of the vehicle 100. However, the position information acquiring unit 116 and GPS receiver 140 may be omitted.

The remote control device 200 includes a computer including a processor 201, a memory 202, an input/output interface 203, and an internal bus 204. The processor 201, the memory 202, and the input/output interface 203 are bidirectionally communicably connected to each other via an internal bus 204. A communication device 205 for communicating with the vehicle 100 by wireless communication is connected to the input/output interface 203.

In the present embodiment, the processor 201 functions as a system control unit 210, a vehicle identifying unit 220, a route planning unit 230, and a remote control command generation unit 240 by executing program PG2 stored in advance in the memory 202.

The system control unit 210 controls the start and stop of transportation of the vehicle 100 and the operation of peripheral devices. The system control unit 210 transmits a control start instruction to the vehicle identifying unit 220 and the route planning unit 230 when the conveyance of the vehicle 100 is started, and transmits a control end instruction when the conveyance of the vehicle 100 is ended. In addition, the system control unit 210 transmits, to the vehicle identifying unit 220 and the route planning unit 230, an authentication code for authenticating the contents of each control instruction in an abnormality detection process, which will be described later, together with the control start instruction and the control end instruction.

Upon receiving the control start instruction from the system control unit 210, the vehicle identifying unit 220 uses the image or the three-dimensional point cloud data acquired from the vehicle detector 300 to acquire information (hereinafter, also referred to as “actual measurement position information”) including at least one of the position and the direction of the vehicle 100. The vehicle identifying unit 220 acquires actual measurement position information at a predetermined cycle until a control end instruction is received from the system control unit 210. The vehicle identifying unit 220 transmits the acquired measured position information to the system control unit 210 and the route planning unit 230. The vehicle identifying unit 220 corresponds to a “moving object identifying unit” in the present disclosure.

Upon receiving the control start instruction from the system control unit 210, the route planning unit 230 uses the measured position information acquired from the vehicle identifying unit 220 to determine a planned route for transporting the vehicle 100. The route planning unit 230 determines the planned route every time the actual measured position information is received from the vehicle identifying unit 220 until the control end instruction is received from the system control unit 210. The planned route determined by the route planning unit 230 includes information specifying at least one of the speed and the steering angle of the vehicle 100 at each point on the planned route, and planned position information. Among the velocities and the steering angles of the vehicles 100, those which are not designated in the planned route may be set in advance for each section along the traveling path SR. “Planned position information” means the estimated position of the vehicle 100 on the planned route at the present time. The planned position information can be estimated, for example, as the position when the vehicle 100 moves at the speed and the steering angle designated in the planned route or at the speed and the steering angle designated in advance with reference to the actually measured position information acquired from the vehicle identifying unit 220 last time. The route planning unit 230 transmits the planned route to the system control unit 210 and the vehicle identifying unit 220. Further, the route planning unit 230 transmits the control state information together with the planned route to the system control unit 210. The “control state information” includes information indicating that the vehicle 100 is traveling or stopped, and information indicating whether or not the vehicle 100 has reached the destination.

The remote control command generation unit 240 generates a control command for remote control so as to cause the vehicle 100 to travel along the planned route determined by the route planning unit 230, and transmits the control command to the vehicle 100. The control command may be generated as a command including a driving force or a braking force and a steering angle. Alternatively, the remote control command generation unit 240 may generate the control command as a command including at least one of the position and the direction of the vehicle 100 and a future travel route.

The process management device 400 manages the overall manufacturing process of the vehicle 100 in the factory. For example, when one vehicle 100 starts traveling along a planned route, individual information indicating an identification number, a type, and the like of the vehicle 100 is transmitted from the process management device 400 to the remote control device 200. The position of the vehicle 100 detected by the remote control device 200 is also transmitted to the process management device 400. Note that the function of the process management device 400 may be implemented in the same apparatus as the remote control device 200.

### A-2. Abnormality Detection Process:

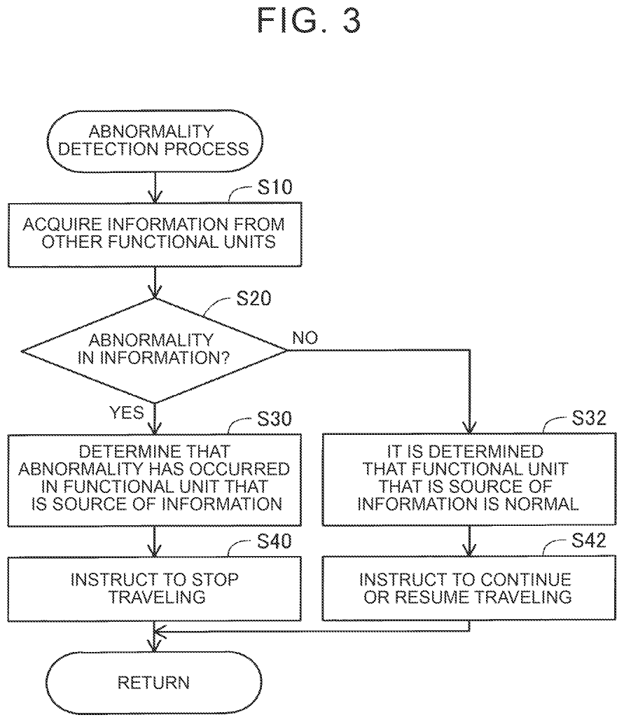

FIG. 3 is a flowchart illustrating a procedure of an abnormality detection process performed by the remote control device 200 according to the present embodiment. This processing is started when the remote control device 200 is activated, and is repeatedly executed in the respective functional units of the system control unit 210, the vehicle identifying unit 220, and the route planning unit 230 while the remote control device 200 is activated.

In S10, each functional unit acquires data from another functional unit. As described above, in the present embodiment, the system control unit 210 acquires the measured position information from the vehicle identifying unit 220, and acquires the planned position information and the control state information from the route planning unit 230. The vehicle identifying unit 220 acquires a control start/end instruction and an authentication code from the system control unit 210, and acquires plan position information from the route planning unit 230. The route planning unit 230 acquires a control start/end instruction and an authentication code from the system control unit 210, and acquires actual measurement position information from the vehicle identifying unit 220. Note that the information transmitted and received by each functional unit is not limited to the above, and may be any information handled by each functional unit. For example, the system control unit 210 and the vehicle identifying unit 220 may acquire, from the route planning unit 230, information specifying at least one of the speed and the steering angle of the vehicle 100 at each point on the planned route in place of the planned position information or in addition to the planned position information.

In S20, the functional units determine whether there is an abnormality in the acquired data. In the present embodiment, when the difference between the position of the vehicle 100 indicated by the measured position information acquired from the vehicle identifying unit 220 and the position of the vehicle 100 indicated by the measured position information acquired last time exceeds a preset threshold value, the system control unit 210 determines that there is an abnormality in the acquired measured position information. In addition, when the difference between the position of the vehicle 100 indicated by the planned position information acquired from the route planning unit 230 and the position indicated by the planned position information acquired last time exceeds a preset threshold value, the system control unit 210 determines that there is an abnormality in the acquired planned position information. The threshold value may be set, for example, as a distance when the vehicle 100 travels at a speed set in advance as an upper limit speed at the time of conveyance in the cycle time of acquisition of the measured position information or the planned position information. This is because, in a case where the normal remote control is performed, the difference does not exceed the threshold value, and therefore, in a case where the difference exceeds the threshold value, there is a high possibility that a defect has occurred in the acquired measured position information itself or the planned position information itself.

The vehicle identifying unit 220 determines that there is an abnormality in the control instruction when there is a difference between the content indicated by the control instruction received from the system control unit 210 and the content of the control instruction indicated by the authentication code. In addition, when the difference between the position of the vehicle 100 indicated by the planned position information acquired from the route planning unit 230 and the position indicated by the planned position information acquired last time exceeds a preset threshold value, the vehicle identifying unit 220 determines that there is an abnormality in the acquired planned position information.

The route planning unit 230 determines that there is an abnormality in the control instruction when there is a difference between the content indicated by the control instruction received from the system control unit 210 and the content of the control instruction indicated by the authentication code. Further, when the difference between the position of the vehicle 100 indicated by the measured position information acquired from the vehicle identifying unit 220 and the position indicated by the measured position information acquired last time exceeds a preset threshold value, the route planning unit 230 determines that there is an abnormality in the acquired measured position information.

When it is determined that there is an abnormality in the acquired information (S20: Yes), in S30, each functional unit determines that an abnormality has occurred in the functional unit that is the source of the information. In S40, the respective functional units generate a control instruction value for instructing to stop traveling via the remote control command generation unit 240, and transmit the control instruction value to the vehicles 100. This is because, in a case where an abnormality occurs in any of the functional units, there is a possibility that a problem may occur in running of the vehicle 100. Note that the correspondence in the case where it is determined that there is an abnormality in the acquired information is not limited to stopping the vehicle traveling, and may be reduction of the speed and the steering angle of the vehicle 100, notification to the administrator, or the like.

On the other hand, when it is determined that there is no abnormality in the acquired information (S20: No), in S32, each functional unit determines that the functional unit that is the source of the information is normal. In S42, the respective functional units generate, via the remote control command generation unit 240, a control instruction value for instructing continuation of traveling, or a control instruction value for instructing resumption of traveling when the traveling is stopped due to an abnormality, and transmit the control instruction value to the vehicles 100.

The functional units repeatedly execute S42 process from S10 described above.

According to the remote control system 10 of the embodiment described above, the functional units of the system control unit 210, the vehicle identifying unit 220, and the route planning unit 230 can detect the presence or absence of an abnormality in the functional unit by using the information received from the other functional units.

In addition, since the functional units of the system control unit 210, the vehicle identifying unit 220, and the route planning unit 230 mutually detect the presence or absence of an abnormality, the abnormality can be detected more stably.

In addition, since at least one of the reduction in the moving speed of the vehicle 100 and the limitation of the steering angle is executed when the abnormality is detected, the amount of movement of the vehicle 100 can be reduced, and the possibility that a problem occurs in the traveling of the vehicle 100 can be reduced.

### B. Other Embodiments

(B1) In the above-described embodiment, the abnormality detection process is executed in each functional unit of the system control unit 210, the vehicle identifying unit 220, and the route planning unit 230, but the present disclosure is not limited thereto. The number of functional units for mutually detecting an abnormality is not limited to three, and may be two, or four or more. The abnormality detection process may be executed in the vehicle control unit 115 included in the vehicle 100 in addition to the system control unit 210, the vehicle identifying unit 220, and the route planning unit 230, or in place of any one of the system control unit 210, the vehicle identifying unit 220, and the route planning unit 230.

(B2) In the above embodiment, the remote control device 200 is configured as one computer, and the system control unit 210, the vehicle identifying unit 220, and the route planning unit 230 are functional units realized by the same computer, but the present disclosure is not limited thereto. The remote control device 200 may be configured as a plurality of computers, and the system control unit 210, the vehicle identifying unit 220, and the route planning unit 230 may be functional units realized by computers different from each other.

(B3) In the above-described embodiment, the system control unit 210, the vehicle identifying unit 220, and the route planning unit 230 mutually detect an abnormality, but the present disclosure is not limited to this. For example, the system control unit 210 may detect an abnormality with only the vehicle identifying unit 220, the vehicle identifying unit 220 only the route planning unit 230, and the route planning unit 230 only the system control unit 210 as targets. In addition, only some of the functional units of the system control unit 210, the vehicle identifying unit 220, and the route planning unit 230 may detect an abnormality of another functional unit.

(B4) In the above-described embodiment, each functional unit detects an abnormality according to the content of information received from another functional unit, but the present disclosure is not limited to this. For example, each functional unit may determine that there is an abnormality in the functional unit when new information is not received for a predetermined time from the time when the previous information is received from another functional unit.

In the above-described embodiment, the vehicle 100 may have a configuration that can be moved by remote control, and may be, for example, in the form of a platform having a configuration described below. Specifically, the vehicle 100 may include at least the vehicle control unit 115 and the communication device 130 in order to perform three functions of “running,” “turning,” and “stopping” by remote control. That is, in the vehicle 100 that can be moved by remote control, at least a part of an interior component such as a driver's seat or a dashboard may not be mounted, at least a part of an exterior component such as a bumper or a fender may not be mounted, and a body shell may not be mounted. In this case, the remaining components such as the body shell may be mounted on the vehicle 100 until the vehicle 100 is shipped from the factory, or the remaining components such as the body shell may be mounted on the vehicle 100 after the vehicle 100 is shipped from the factory in a state where the remaining components such as the body shell are not mounted on the vehicle 100. It should be noted that for the form of the platform, position determination can be performed in the same manner as in the vehicle 100 in each embodiment.

The present disclosure is not limited to each of the above embodiments, and can be realized by various configurations without departing from the spirit thereof. For example, the technical features in the embodiments corresponding to the technical features in the respective embodiments described in the Summary of the Disclosure can be appropriately replaced or combined in order to solve some or all of the above-described problems or to achieve some or all of the above-described effects. Further, when the technical features are not described as essential in the present specification, these can be deleted as appropriate.

What is claimed is:

1. A remote control system that remotely controls a moving object to move automatically, the remote control system comprising a plurality of functional units that sends and receives information to and from each other, wherein at least part of the functional units detects presence or absence of an abnormality in a remainder of the functional units by using information received from the remainder of the functional units.

2. The remote control system according to claim 1, wherein the functional units include a route planning unit that determines a route along which the moving object is to be moved, and a moving object identifying unit that acquires either or both of a position and orientation of the moving object.

3. The remote control system according to claim 2, wherein the route planning unit and the moving object identifying unit mutually detect the presence or absence of the abnormality.

4. The remote control system according to claim 2, further comprising a functional unit that performs either or both of the following operations when the abnormality is detected in either or both of the route planning unit and the moving object identifying unit: reducing a moving speed of the moving object, and limiting a steering angle.
